(19) United States
(12) Patent Application Publication
(10) Pub. No.: US 2009/0174460 A1
(43) Pub. Date: Jul. 9, 2009

(54) Method of third-order transconductance cancellation and linear mixer thereof

(75) Inventors: Yi-Jen Chan, Jhongli City (TW); Kung-Hao Liang, Taipei City (TW); Hong-Yeh Chang, Zhonghe City (TW)

Correspondence Address: TROXELL LAW OFFICE PLLC;SUITE 1404, 5205 LEESBURG PIKE, FALLS CHURCH, VA, 22041, US

(73) Assignee: National Central University, Taoyuan (TW)

(21) Appl. No.: 12/076,711

(22) Filed: Mar. 21, 2008

(30) Foreign Application Priority Data
Jan. 3, 2008 (TW) 097100130

(51) Int. Cl. G06G 7/16

(52) U.S. Cl. 327/356

(57) ABSTRACT

A third-order transconductance (gₘ₃) cancellation is utilized to obtain a highly linear mixer. Transistors obtain good linearity with complementary gₘ₃ values. The transistor thus obtained can be operated in a wide bandwidth and is applicable to various frequency specifications of systems, like Bluetooth, wireless LAN, Ultra-Wide Band (UWB), etc. Then the transistors are applied to design a transconductance-stage input of the mixer. Hence, the present invention can be widely applied to receiver modules and be realized with a low-cost CMOS transistor.

### FIELD OF THE INVENTION

The present invention relates to a third-order transconductance cancellation; more particularly, relates to a transistor obtaining a high linearity through the cancellation to be applied in a mixer.

### DESCRIPTION OF THE RELATED ARTS

Transistor is an active device short of linearity. On applying the transistor in a circuit design, a linearity of the circuit is directly affected. Hence, a linear transistor is required to be developed. Yet, improvements have only been done on limited kinds of circuits, which greatly limit their applications.

A receiver at a radio frequency (RF) port requires better linearity to provide better transmission according to requirements on transmission amount and speed. As shown in FIG. 8, a general receiver module 7 comprises a power amplifier 71, a low noise amplifier 72, a mixer 73 and a voltage controlled oscillator 74. In general, the receiver module 7 obtains its non-linearity through the power amplifier 71 and the mixer 73. Improvement methods developed for non-linearity of mixers usually require extra power consumption or circuit complexity. Hence, reliability and workability of circuit are often sacrificed.

As shown in FIG. 9, a Gilbert-cell mixer 8 comprises an RF transconductance stage 81, an LO switching stage 82 and an output load 83. Usually, the RF transconductance stage 81 is operated in a saturation region to obtain a high gain and a low noise figure. The LO switching stage 82 is operated in a pinch-off region to control an open/close state through a state of an LO signal inputted. The output load 83 is connected with a load resistor to transform a current signal into a voltage signal. And usually an output buffer is further provided for resistance matching to obtain a high output power. Thus, the RF transconductance stage 81 is acted as a circuit gain stage to decide a circuit gain, a noise figure and a circuit linearity of the whole mixer. However, although the circuit has a 0˜5 dB circuit gain, extra 5˜10 milliwatts (mW) of power consumption are required.

A general common-source amplifier, comprising a gate source capacitance, a drain source capacitance, a gate drain capacitance, a transconductance and a drain conductance, is a non-linear component. Therein, the transconductance contributes the major part of the non-linear characteristic and is a main cause of a third-order intermodulation distortion (IMD3). Hence, linearity of a transistor can be improved by reducing or cancelling third-order non-linearity of the transconductance.

As shown in FIG. 10, three curves are obtained by measuring a first-order transconductance (gₘ) 91, a second-order transconductance (gₘ₂) 92 and a third-order transconductance (gₘ₃) 93 of an n-channel metal oxide semiconductor (NMOS) transistor. When a gate voltage is between 0.4 volts (V) and 0.5V, the gₘ₃ has a highest negative value. On increasing the gate voltage, the gₘ₃ is reduced and passes through the zero value. When the gate voltage is between 0.6V and 0.8V, the gₘ₃ has a highest positive value. Generally speaking, the common-source amplifier is operated with a voltage between 0.6V and 0.8V (a saturation region) at the gate to obtain a high circuit gain. Yet, although the gₘ₃ has a highest positive value when operated in the saturation region, the linearity is the worst at the same time. In a word, circuit gain and linearity are usually contradicted with each other. Hence, the prior arts do not fulfill all users' requests on actual use.

### SUMMARY OF THE INVENTION

The main purpose of the present invention is to obtain a high linear transistor through a gₘ₃ cancellation, to use the transistor in a transconductance input of a mixer to effectively improve linearity of the mixer, and to widely apply the mixer in receiver modules and others devices requiring high linearity.

The second purpose of the present invention is to operate the linear transistor in a wide bandwidth for various frequency specifications of systems, like Bluetooth, wireless LAN, Ultra-Wide Band (UWB), etc.

The third purpose of the present invention is to widely apply the present invention in receiver modules and be realized with a complementary metal oxide semiconductor (CMOS) transistor, which has a low cost.

To achieve the above purposes, the present invention is a method of a gₘ₃ cancellation and a linear mixer thereof, where the gₘ₃ cancellation comprises steps of: (a) inputting bias voltages from bodies of transistors to change threshold voltages of the transistors according to a matrix effect function to shift gₘ₃ peak values, and (b) obtaining a parallel connection of the transistors to process a gₘ₃ cancellation; and where the linear mixer comprises an RF trans conductance stage transforming an RF signal of voltage into a signal of current, an LO switching stage operating the bias voltage in a pinch-off region to control a state of opening/closing of the LO switching stage with an LO signal inputted; an output load being a resistance component having an impedance value and further being an active load; and an output buffer receiving an up/down-converted signal generated from a circuit and amplifying the up/down-converted signal. Accordingly, a novel method of a gₘ₃ cancellation and a linear mixer thereof are obtained.

### BRIEF DESCRIPTION OF THE DRAWINGS

The present invention will be better understood from the following detailed description of the preferred embodiment according to the present invention, taken in conjunction with the accompanying drawings, in which

FIG. 1 is the flow view showing the gₘ₃ cancellation of the preferred embodiment according to the present invention;

FIG. 2 is the view showing the null transconductance measurement of the parallel transistors;

FIG. 3 is the view showing the IIP3 measurement of the parallel transistors;

FIG. 4 is the view showing the ACPR measurement of the parallel transistors;

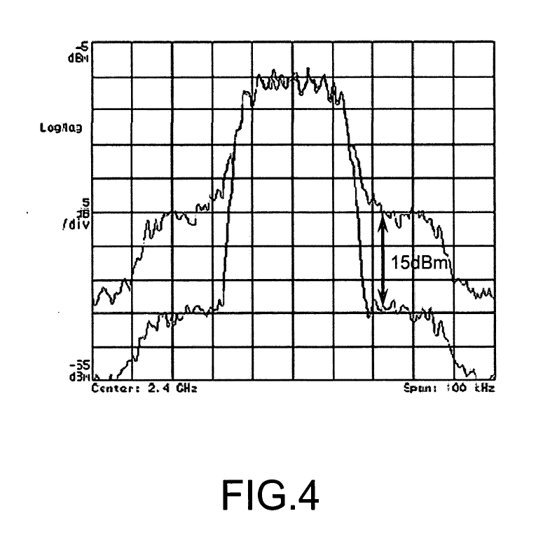

FIG. 5 is the structural view showing the linear mixer;

FIG. 6 is the view showing the IIP3 measurement of the linear mixer;

FIG. 7 is the view showing the ACPR measurement of the linear mixer;

FIG. 8 is the view of the general receiver module;

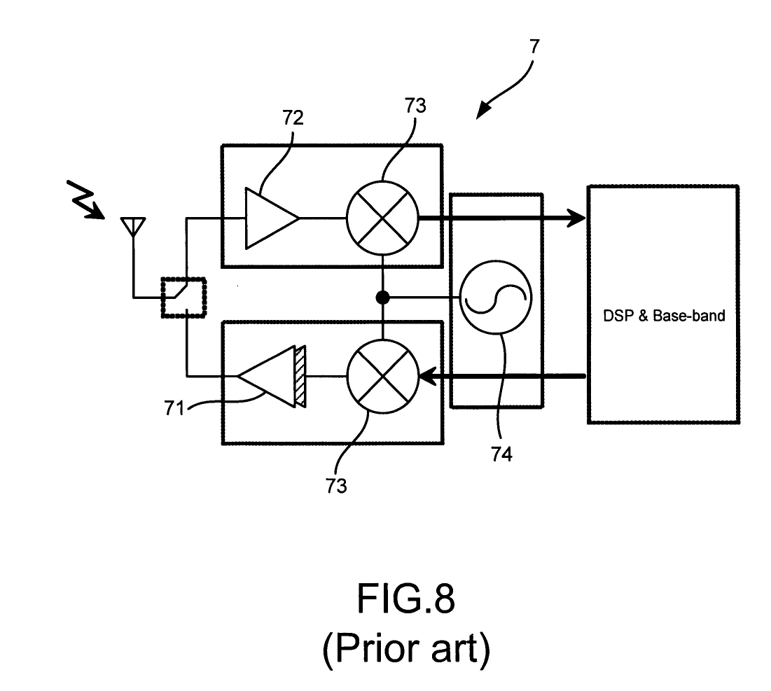

FIG. 9 is the structural view of the general Gilbert-cell mixer; and

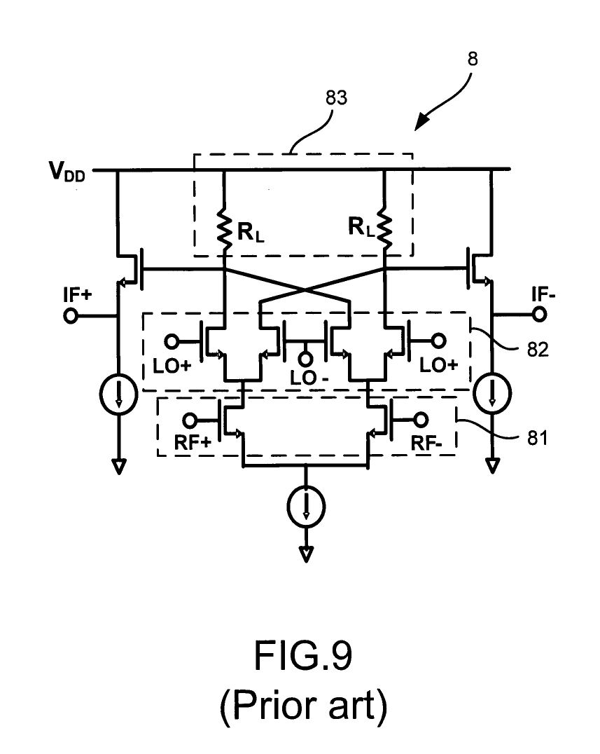

FIG. 10 is the view of the transconductance measurement of the NMOS transistor.

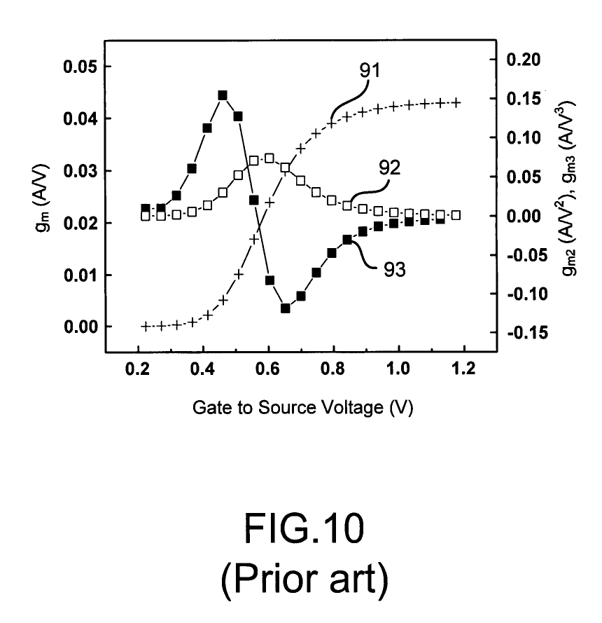

### DESCRIPTION OF THE PREFERRED EMBODIMENT

The following description of the preferred embodiment is provided to understand the features and the structures of the present invention.

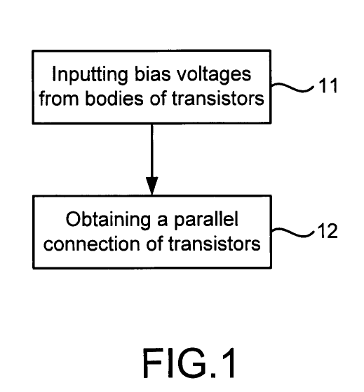

Please refer to FIG. 1, which is a flow view showing a third-order transconductance (gₘ₃) cancellation of a preferred embodiment according to the present invention. As shown in the figure, the present invention is a method of a gₘ₃ cancellation and a linear mixer thereof. The gₘ₃ cancellation comprises the following steps:

(a) Inputting bias voltages from bodies of transistors 11: A transistor comprises a p-channel metal oxide semiconductor (PMOS) transistor and an n-channel metal oxide semiconductor (NMOS) transistor. Positive/negative bias voltages are inputted from a body of the PMOS transistor and a body of the NMOS transistor separately. Meanwhile, threshold voltages of the PMOS transistor and the NMOS transistor are changed by the bias voltages according to a matrix effect function; and transconductance curves are changed by the threshold voltages to shift gₘ₃ peak values. Therein, each of the PMOS transistor and the NMOS transistor has four ports of a gate port, a drain gate, a source port and a body port; the gₘ₃ is obtained by differentiating a gate voltage of a first-order transconductance for two times; and, the matrix effect function has a third-order intercept point (IP3) of a common-source transistor, where linearity of the IP3 is improved by reducing gₘ₃ with a formula of

$$IP 3 = \sqrt{\frac{4}{3} \frac{{g}_{m}}{{g}_{m 3}}} .$$

(b) Obtaining a parallel connection of transistors 12: At least two transistors having positive/negative gₘ₃ values are connected in a parallel way to process a gₘ₃ cancellation.

Thus, with the bias voltages inputted from the bodies, threshold voltages and transconductance characteristics of the transistors are changed. And, by connecting the transistors in a parallel way, a gₘ₃ cancellation is obtained to form a smooth gₘ₃ region. By operating voltages of the transistors in the smooth gₘ₃ region, a good linearity is obtained by applying the transistors to circuits requiring high linearity.

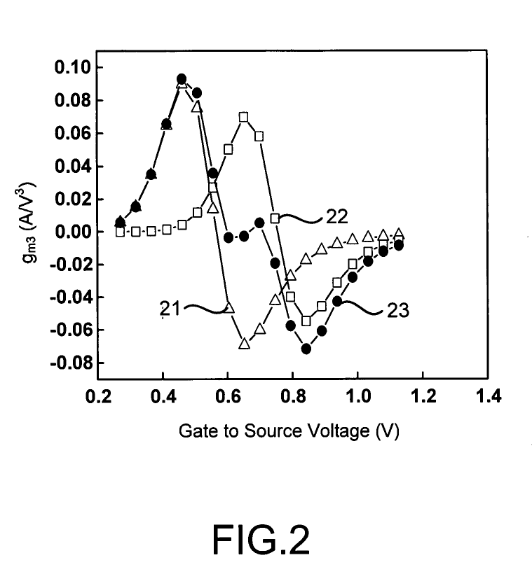

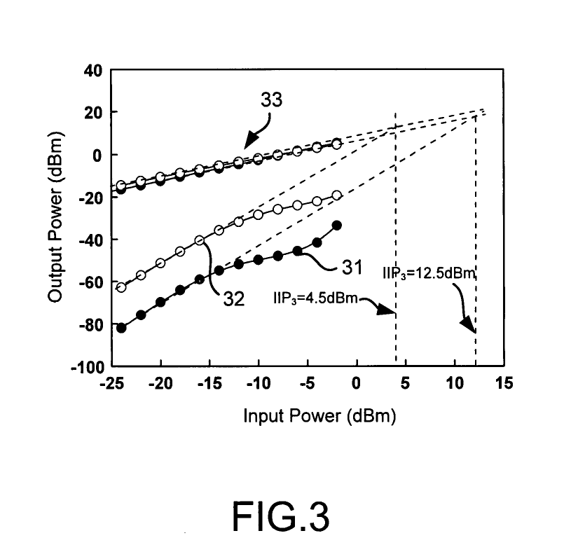

Please refer to FIG. 2 to FIG. 3, which is a view showing a gₘ₃ measurement, an IIP3 measurement and an ACPR measurement of parallel transistors. As shown in the figures, gₘ₃ curves are measured with two transistors operated under different situations, including a first transconductance curve 21 for 0 volt (V) bias voltage at body and a second transconductance curve 22 for −1V bias voltage at body. Because bias voltages at body shift the first transconductance curve 21 and the second transconductance curve 22 and two transistors are connected in a parallel way, a complementary transconductance curve 23 is obtained. As shown in FIG. 3, a smooth gₘ₃ is obtained with an operation under a voltage between 0.6V and 0.7V. Hence, the transistors obtain high IP3 values according to a matrix effect function with linearity of the transistors improved; and a mixer designed with the transistors having such bias voltages obtains a best circuit gain.

As shown in the IP3 measurement, through complementary gₘ₃ for an intercept point curve of w/gₘ₃ 31 and an intercept point curve of w/ogₘ₃ 32, a complementary intercept point curve 33 is formed, where a 12.5 dB improvement of third-order intermodulation distortion (IMD3) and a 8 dB improvement of input third-order intercept point (IIP3) are thus obtained. Besides, an adjacent channel power ratio (ACPR) is measured and a 15 dB improvement of ACPR is obtained through the above method.

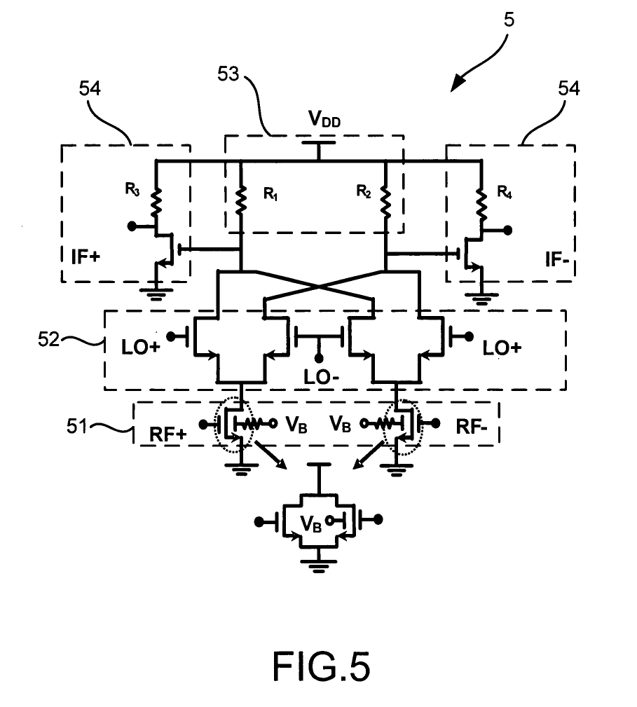

Please refer to FIG. 5, which is a structural view showing a linear mixer. As shown in the figure, a linear mixer 5 according to the present invention comprises an RF transconductance stage 51, an LO switching stage 52, an output load 53 and an output buffer 54.

The RF transconductance stage 51 transforms an RF signal of voltage into a signal of current; and comprises two transistors.

The LO switching stage 52 operates the bias voltage in a pinch-off region where an inputted LO signal is used to control an open/close state. And the LO switching stage 52 comprises two transistors.

The output load 53 is a resistance component having an impedance value and is further an active load, where the output load 53 is a resistor, an inductor or a transistor; and the transistor is a metal oxide semiconductor (MOS) transistor.

The output buffer 54 receives an up/down-converted signal generated from a circuit and amplifying the up/down-converted signal. The output buffer 54 comprises two transistors and has a common-gate configuration, a common-source configuration or a common-drain configuration.

Therein, the linear mixer 5 has a single-end circuit, a single-balance circuit or a double-balance circuit; and the linear mixer 5 outputs a down-converted signal obtained from a frequency difference between an RF signal and an LO signal or an up-converted signal obtained from a sum of frequencies of an RF signal and an LO signal.

In addition, the RF transconductance stage 51, which determines a circuit gain and a linearity of the mixer 5, is obtained through a parallel connection of two transistors for a complementary gₘ₃. Gate widths of the two transistors are 37.5 micrometers (μm) and 50 μm separately; and a near-zero measurement of gₘ₃ is thus obtained with the above component.

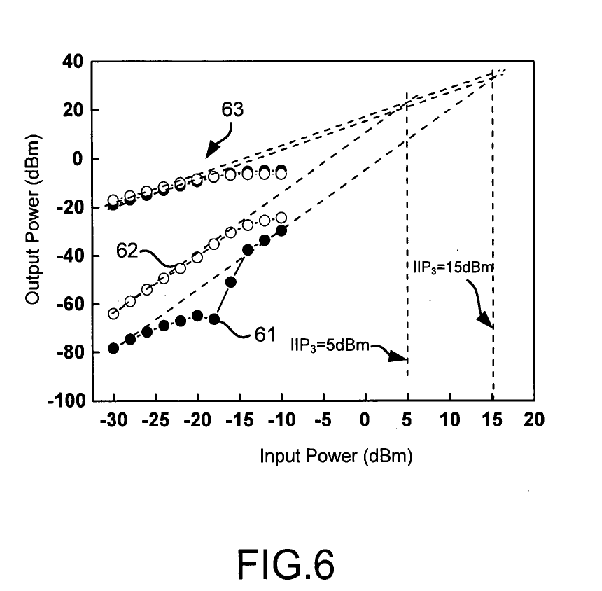

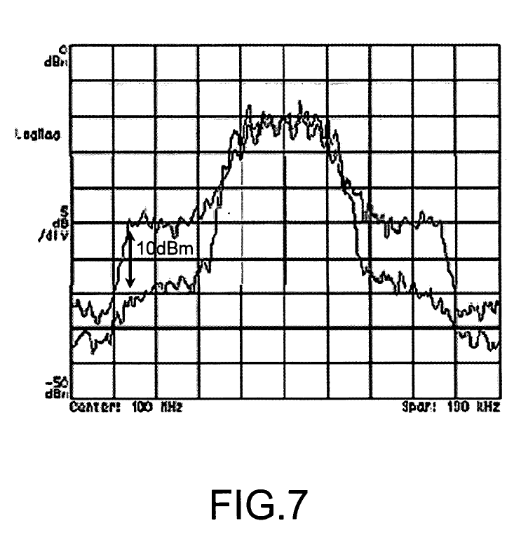

Please refer to FIG. 6 and FIG. 7, which are views showing an IIP3 measurement and an ACPR measurement of a linear mixer. As shown in the figures, a linear mixer according to the present invention is measured for its IP3. After a complementary gₘ₃ is processed to an intercept point curve for w/gₘ₃ 61 and an intercept point curve for w/ogₘ₃ 62 to obtain a complementary intercept point curve 63, a 15 dB improvement for IMD3 and a 10 dB improvement for IIP3 are obtained Regarding ACPR measurement, when the linear mixer is inputted with an RF frequency of 2.4 giga-hertz (GHz) and an LO frequency of 2.3 GHz, an intermediate frequency (IF) of 100 maga-hertz (MHz) is outputted, which results in an improvement of 10 dB. Thus, the present invention effectively enhances a linearity of a circuit and improves operational stability of the circuit without increasing its circuit complexity or reducing its circuit characteristics.

Hence, a gₘ₃ cancellation is used to obtain a transistor having an improved high linearity. Then the transistor is applied to design a transconductance input of a mixer for improving linearity of the mixer. Thus, a mixer having a high linearity is obtained to be operated in a wide bandwidth for various frequency specifications of systems, like Bluetooth, wireless LAN, Ultra-Wide Band (UWB), etc. Consequently, the present invention can be widely applied in receiver modules and can be realized with a complementary metal oxide semiconductor (CMOS) transistor, which has a low cost.

To sum up, the present invention is a method of a gₘ₃ cancellation and a linear mixer thereof, where a high linear transistor is obtained through a gₘ₃ cancellation; the transistor is used in a transconductance input of a mixer to effectively improve linearity of the mixer; and the mixer can be widely applied to the receiver modules and others devices requiring high linearity.

The preferred embodiment herein disclosed is not intended to unnecessarily limit the scope of the invention. Therefore, simple modifications or variations belonging to the equivalent of the scope of the claims and the instructions disclosed here in for a patent are all within the scope of the present invention.

What is claimed is:

1. A method of a third-order transconductance (gₘ₃) cancellation, comprising steps of:
(a) inputting bias voltages from bodies of transistors to change threshold voltages of said transistors according to a matrix effect function to shift gₘ₃ peak values; and
(b) obtaining a parallel connection of said transistors to process a gₘ₃ cancellation.

2. The method according to claim 1, wherein said transistor comprises a p-channel metal oxide semiconductor (PMOS) transistor and an n-channel metal oxide semiconductor (NMOS) transistor.

3. The method according to claim 1, wherein said matrix effect function has a formula of
$$IP 3 = \sqrt{\frac{4}{3} \frac{{g}_{m}}{{g}_{m 3}}} .$$

4. The method according to claim 1, wherein said parallel connection in step (b) comprises at least two transistors.

5. The method according to claim 4, wherein said parallel connection comprises two transistors and said two transistors have a gate width of W₁ (37.5) micrometers (μm) and a gate width of W₂ (50) μm separately. The gate lengths of W₁ and W₂ can be varied from cm to nm.

6. A linear mixer having a gₘ₃ cancellation, comprising:
an RF transconductance stage, said RF transconductance stage transforming an RF signal of voltage into a signal of current;
an LO switching stage, said LO switching stage operating said bias voltage in a pinch-off region to control a state of opening/closing of said LO switching stage with an LO signal inputted;
an output load, said output load being a resistance component having an impedance value, said output load further being an active load; and
an output buffer, said output buffer receiving an up/down-converted signal generated from a circuit and amplifying said up/down-converted signal.

7. The linear mixer according to claim 6, wherein said output load is selected from a group consisting of a resistor, an inductor and a transistor.

8. The linear mixer according to claim 7, wherein said transistor is a metal oxide semiconductor (MOS) transistor.

9. The linear mixer according to claim 6, wherein said output buffer has a configuration selected from a group consisting of a common-gate configuration, a common-source configuration and a common-drain configuration.

10. The linear mixer according to claim 6, wherein said linear mixer comprises a circuit selected from a group consisting of a single-end circuit, a single-balance circuit and a double-balance circuit.

11. The linear mixer according to claim 6, wherein said linear mixer outputs a signal selected from a group consisting of a down-converted signal and an up-converted signal.

12. The linear mixer according to claim 11, wherein said down-converted signal is obtained from a frequency difference between an RF signal and an LO signal.

13. The linear mixer according to claim 11, wherein said up-converted signal is obtained from a sum of frequencies of an RF signal and an LO signal.
